(19) United States
(12) Patent Application Publication
(10) Pub. No.: US 2018/0311891 A1
(43) Pub. Date: Nov. 1, 2018

(54) Z-AXIS IMPROVEMENT IN ADDITIVE MANUFACTURING

(71) Applicant: UT-BATTELLE, LLC, OAK RIDGE, TN (US)

(72) Inventors: Chad E. DUTY, Loudon, TN (US); Seokpum KIM, Knoxville, TN (US); Vlastimil KUNC, Concord, TN (US); Lonnie J. LOVE, Knoxville, TN (US); Brian K. POST, Knoxville, TN (US); Jordan A. FAILLA, Signal Mountain, TN (US); John M. LINDAHL, Knoxville, TN (US)

(73) Assignee: UT-BATTELLE, LLC, OAK RIDGE, TN (US)

(21) Appl. No.: 15/965,106

(22) Filed: Apr. 27, 2018

Related U.S. Application Data
(60) Provisional application No. 62/491,313, filed on Apr. 28, 2017.

(51) Int. Cl. B29C 64/118; B33Y 10/00; B33Y 80/00; B29C 64/35; B33Y 40/00

(52) U.S. Cl. CPC B29C 64/118; B33Y 10/00; B29K 2995/002; B29C 64/35; B33Y 40/00; B33Y 80/00

(57) ABSTRACT

An additive manufacturing method and component having a fill layer material injected into voids as a Z-direction liquid nail or pin to provide a better connection between layers. Rather than depositing a complete layer, the extruder stops extruding at certain sections of the layers to leave a void. This repeats in the same location for the next predetermined number of layers, to create a series of vertically aligned voids in the print. Once the void hole is deep enough, the extruder will go back to this hole after completing the layer and fill it in. When this is done, the material flows down to the bottom of the hole and fill in the hole until it reaches the level of the most recent layer. This can be done a plurality of times on each layer.

### CROSS REFERENCE TO RELATED APPLICATION

This application claims the benefit of U.S. Provisional Application, Ser. No. 62/491,313, filed on 28 Apr. 2017. The co-pending Provisional Application is hereby incorporated by reference herein in its entirety and is made a part hereof, including but not limited to those portions which specifically appear hereinafter.

### STATEMENT REGARDING FEDERALLY SPONSORED RESEARCH AND DEVELOPMENT

This invention was made with government support under Contract No. DE-AC05-000R22725 awarded by the U.S. Department of Energy. The government has certain rights in the invention.

### FIELD OF THE INVENTION

This invention relates to 3D printing or additive manufacturing, and more particularly to methods and articles of manufacture for improved strength in the out-of-plane or Z-axis direction.

### BACKGROUND OF THE INVENTION

The popularity of 3D printing has grown sharply in the last several years due primarily to the emergence of the desktop 3D printer, generically known as fused filament fabrication (FFF) or additive manufacturing. However, the utilization of FFF technology is largely restricted to the production of demonstration pieces, models, and prototypes that test only the form and fit of a given design. The functionality of a printed component is often limited by poor mechanical performance. Although engineering polymers, such as acrylonitrile butadiene styrene (ABS), are used for 3D printing applications, the component-level strength of a printed part can be a fraction (as low as 25-50%) of the cited reference strength for that material, typically from a compression or injection molded reference.

The relatively poor mechanical performance of FFF parts is largely due to the manner in which material is deposited during the extrusion-based printing process. Although the technology is popularly referred to as “3D printing”, the traditional approach to building a three dimensional geometry by successively stacking 2D layers of deposited material can more accurately described as ‘2.5-D printing’. The layered structure of a traditionally-printed component is immediately apparent by close inspection of a given cross section. Using the conventional nomenclature where the deposition plane is the X-Y plane and the Z-axis is directed vertically across layers, it is evident that FFF printing can align continuous material in any specific direction within the X-Y plane, but there is no continuous material crossing between successive layers. Therefore, transferring a load in the Z-direction must occur across the discrete bonded areas where the deposited beads in successive layers interact. At best, these bonded areas are intermittent across a given load path and are subject to stress concentrations due to the sharp interfaces where the curved surfaces of the beads intersect. There is a continuing need for improved FFF techniques that impart strength and stability to printed components.

### SUMMARY OF THE INVENTION

A general object of the invention is to provide a method for and an article of manufacture having improved Z-direction strength.

The invention includes a method for making an article with an additive manufacturing machine. The method includes depositing an initial layer of a material in a 2D (X-Y axis) deposition plane with the additive manufacturing machine so that the layer defines at least one void area having a depth measured in an axis direction (Z-axis) that is perpendicular to the 2D plane. The method further includes depositing a fill layer of the material or a second material on top of the initial layer with the additive manufacturing machine so that a portion of the material or the second material deposited in the fill layer extends into the at least one void to form an interlocking feature between the initial layer and the fill layer.

The void preferably extends through two or more layers. The fill layer extends at least partially in the Z-direction to fill the void and form a post, pin, or ‘liquid nail’ extending through the layers, thereby providing better connection between the layers. This method changes the way the printed article is sliced and how the material is deposited. Rather than depositing the complete layer, the extruder will stop extruding at certain sections of the layers. This will repeat in the same location for the next few layers which will create a void or hole in the print in the Z-axis direction. Once the hole is deep enough, the extruder goes back to this hole after completing the layer and fills it in. When this is done, the fill layer material will flow down to the bottom of the void hole that was created and fill in the hole until, for example, it reaches the level of the most recent layer. This will be done several times on each layer and desirably spread out and/or relatively equally dispersed. These liquid nails can be strategically distributed throughout the part and between successive layers so that every layer will be interconnected by these nails.

Intentional voids that are filled with “pins” of this invention can result in a fully dense part when completed. Other embodiments of this invention utilize a ‘sparse fill’ structure (e.g., a rectilinear grid or honeycomb-like structure) to create regular interconnected porosity throughout the printed part. The design of sparse fill geometries can vary widely with corresponding differences in resulting bonding between layers. Software changes for existing printing machine controllers can be provided to implement the various fill layer and liquid nails of this invention according to site-specific fill operation at strategic locations.

The invention improves layer strength as the liquid polymer is extruded into these void holes. The fill layer material fills some or all of the gaps made in between the layers and desirably mechanically interlocks with the rough surface in the internal diameter of the void hole. Although mechanical interlocking is generally the primary mechanism of bonding, chemical bonding and/or thermal diffusion bonding can additionally occur and be considered for material choice in a part design. When the fill material solidifies, the void hole desirably is mostly or fully filled as well as any gaps between the extruded beads at each layer. For fiber-reinforced materials, this technique can change the alignment of the carbon fibers to bridge across successive layers rather than or in addition to the parallel fibers that often occur within a given layer due to shear alignment.

The pin or nail material can be the same or different from the initial layers. The pins can be used join two or more layers of dissimilar materials. The joining of dissimilar materials with like or dissimilar materials can be extended to include multiple layers of multiple materials joined with two or more different pin materials.

The invention further includes a three-dimensional article of manufacture made with an additive manufacturing machine. An initial layer of a material is deposited in a 2D or X-Y plane and defines at least one void area having a depth measured in an axis direction (third Z-direction) that is perpendicular to the plane. A fill layer of a fill layer material is deposited on top of the initial layer, wherein a portion of the fill layer material deposited in the fill layer extends into the at least one void area to form an interlocking feature between the initial layer and the fill layer. The at least one void and the portion of the fill layer desirably each extends through more than one layer of material to form the interlocking feature between the more than one layer of material. In some preferred embodiments a plurality of voids exist in a printed article of manufacture, where the voids and fill material ‘nails’ are offset throughout the article so that all of the ‘nailed’ layers are interconnected by these nails.

Other objects and advantages will be apparent to those skilled in the art from the following detailed description taken in conjunction with the appended claims and drawings.

### BRIEF DESCRIPTION OF THE DRAWINGS

FIG. 1 is a schematic of an additive manufacturing system according to one embodiment of this invention.

FIG. 2 is a side view of a nozzle according to one embodiment of this invention.

FIG. 3 shows a portion of a component build with voids according to one embodiment of this invention.

FIG. 4 shows a portion of a component build with voids according to another embodiment of this invention.

FIGS. 5A-F illustrate a ‘Z-pinning’ approach according to one embodiment of this invention.

FIGS. 6A-B illustrate exemplary in-fill patterns, according to embodiments of this invention.

FIGS. 7-10 each shows a liquid nail fill pattern according to one embodiment of this invention.

FIGS. 11A and 11B show a rectilinear grid system with an infill shape according to one embodiment of this invention, without and with Z-pins.

FIG. 12 shows the tensile sample geometry used in the examples.

FIG. 13 summarizes a tensile test of 35% infill sample without and with Z-pins.

FIG. 14 summarizes strength of Z-pin samples compared to control samples.

FIG. 15 summarizes toughness of Z-pin samples compared to control samples.

FIG. 16 shows the fracture surface of representative tensile specimens.

### DETAILED DESCRIPTION OF THE INVENTION

The present invention provides methods for making an article with an additive manufacturing machine that provides improved Z-direction strength and/or stability. The method deposits a plurality of X-Y layers according to conventional additive manufacturing, but leaves predetermined void areas or holes in the build, which after deposition of more than one layer can extend continuously through the more than one X-Y build layers. An additional layer of a material is deposited in the void areas to act as a Z-direction pin to provide interlocking strength (e.g., mechanical, chemical, and/or thermal diffusion interlocking) between the corresponding X-Y layers.

Embodiments of this invention improve layer strength by filling each of the void areas with a liquid polymer ‘pin’ or ‘nail’ that fills the void, and desirably also any gaps between the layers adjacent the voids, and mechanically interlocks with the surface in the internal walls of the void. When the fill material solidifies, the entire hole is desirably filled as well as the adjacent gaps between the extruded beads at each layer.

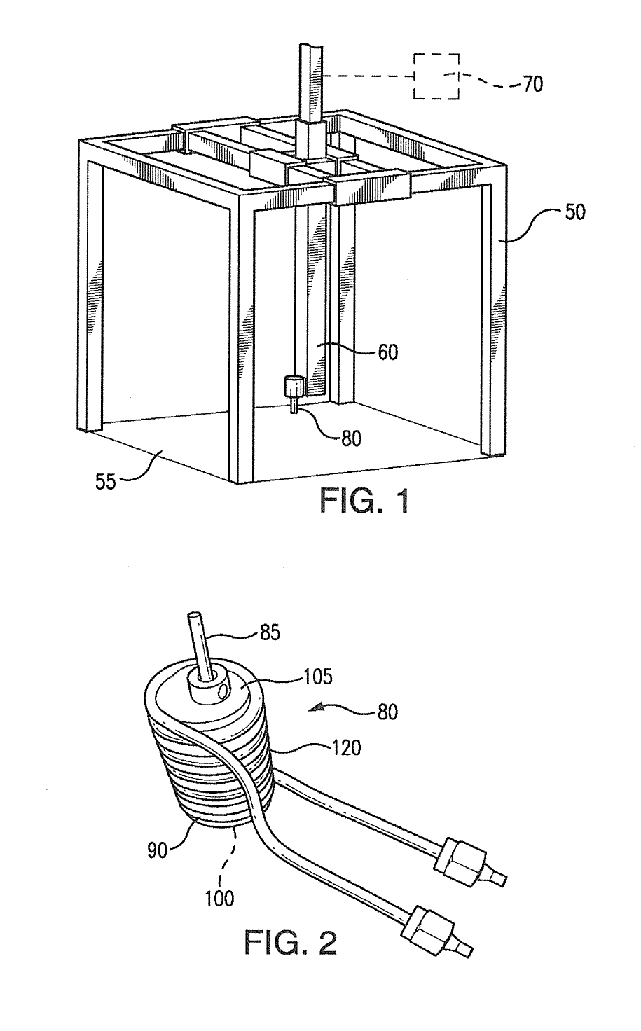

The invention can be incorporated in most, if not all, additive manufacturing systems, both large scale and small build machines. Although not required, the subject invention may be used in connection with large scale polymer additive manufacturing such as the schematic shown in FIG. 1. FIG. 1 shows a frame or gantry 50 for containing a build on surface 55. The gantry 50 preferably contains a deposition arm 60 that is moveable through the X, Y and Z-axis, via controller 70. The deposition arm 60 preferably accommodates a supply of working material and a deposition nozzle 80. The supply of working material may be onboard the deposition arm and/or remotely supplied from a hopper or similar storage vessel.

According to an exemplary embodiment of the invention, a method of additive manufacturing includes the steps of providing an apparatus for additive manufacturing, for instance the gantry system shown in FIG. 1. The apparatus preferably includes a deposition head or nozzle 80 for extruding a material, such as shown in FIG. 2. The invention is not limited to any particular nozzle. In the nozzle embodiment of FIG. 2, the nozzle 80 is particularly useful for a polymeric working material that is magnetically susceptible and/or electrically conductive for electromagnetic heating of the material for deposit. FIG. 2 shows a preferred embodiment of the nozzle 80 including a barrel 85 through which the working material is provided, a plate 90 and a tip 100 from which the working material is directly deposited on the build. A coil 120 is preferably wrapped around the barrel and comprises an assembly that may further include a thermally conductive wrap 105 around the barrel 85, for instance, boron nitride. Again, this invention is not limited to this type of nozzle, and other nozzle and extruder configurations may be used.

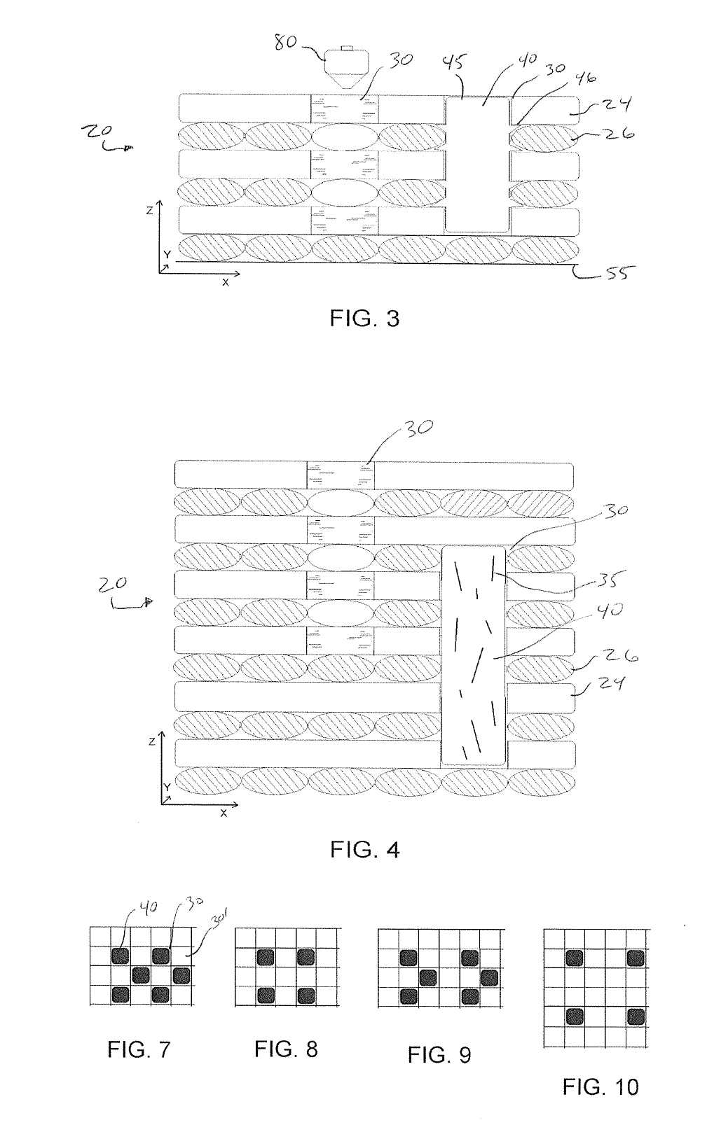

FIG. 3 illustrates an additive manufacturing layer build 20 according to one embodiment of this invention. Two-dimensional (X-Y) layers 24, 26 are deposited by a nozzle 80 on a build surface 55, with layers 24 deposited at an angle (e.g., 90°) in the X-Y direction to the layers 26. The build 20 includes void areas 30 extending in the Z-direction, perpendicular to the X-Y planes, through multiple layers 24, 26.

The nozzle 80 has deposited a fill layer 40 into one of the voids 30 to form a liquid nail 45 that cures/hardens through the inter-layer void to provide Z-direction structural strength. As the fill layer 40 is deposited as a flowing liquid polymer material, this fill layer 40 includes anchoring extensions 46 that result from material filling any gaps forming between the beads of layers 24 and 26. The anchoring extension can be particularly useful for printing with multiple materials (even across broad material categories such as thermoplastics, thermosets, ceramics, metals, composites, etc.) that do not share common processing conditions that are suitable for bonding.

FIG. 4 illustrates an embodiment of this invention with alternating layer pinning The height of each void 30 is equivalent to eight build layers. As with the pin volume, the optimal pin length can be a complex function of several other variables within the build and for a given material. For a part with hundreds of layers, for example, voids 30 are filled (or pinned) at every eighth layer. In FIG. 4, half of the total number of voids are filled at every eighth layer starting from zero layer (i.e., 8, 16, 24, . . . ), and the other half of the voids 30 are filled at every eighth layer starting from 4th layer height (i.e., 12, 20, 28, . . . ). Using this method, the initial half number of voids are engaged with the other half voids at every fourth layer. This is just one specific embodiment, and the optimal spacing and length of the pins could vary dramatically for a given material & geometry. The offset or overlapping pins 45 provide the part with high tensional strength in the vertical, Z, or cross-layer direction. Fiber-reinforced pins can optionally be used, and the alignment of the carbon fibers 35 can bridge across successive layers 24/26 rather than or in addition to the parallel fibers that often incorporated in the X-Y layer materials.

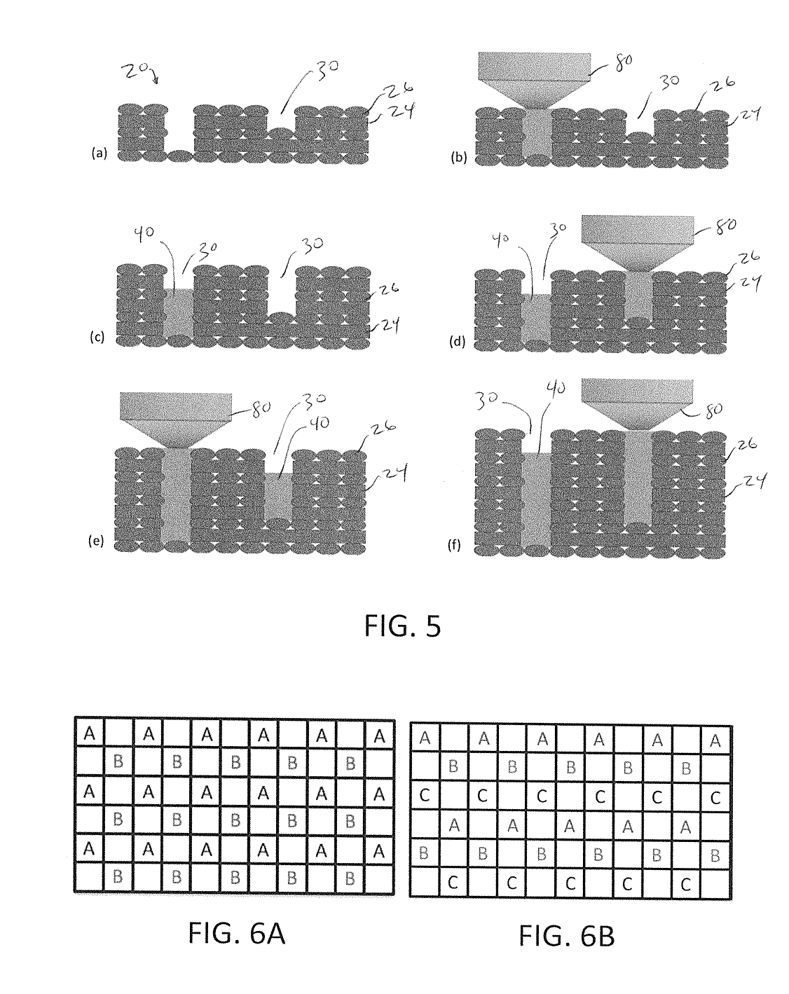

FIGS. 5A-F illustrate a ‘Z-pinning’ approach according to one embodiment of this invention. The nozzle 80 deposits continuous material across multiple layers 24/26 in a printed component, effectively stitching together the layered 2.5D structure in the third dimension (Z-axis). As shown in FIGS. 5A-F, the Z-pinning process involves aligning voids across multiple (n) layers, which are then back-filled in a continuous fashion during the deposition of layer (n+1) or as a separate step between layers (n) and (n+1). As shown, the Z-pinning method of this embodiment begins with leaving intentionally aligned voids 30 across (n) layers in the standard cross-hatch infill pattern of a printed component (n=4 in FIG. 5A). Either during or prior to deposition of the following layer (n+1), the deposition head moves into position above the opening and remains stationary while extruding material to fill the void (FIG. 5B). Additional openings are present in FIG. 5B that will not be filled after layer (n) because they are the locations of pins that will be deposited in later steps. FIG. 5C illustrates that as the printing process continues for additional layers, voids are aligned above the previously deposited pin as well as in neighboring locations for the placement of staggered pins. In this example of two pin locations, after deposition of layer (n+n/2) in FIG. 5C, the deposition head nozzle 80 is positioned over the alternate pin location and extrudes material (n) layers deep to fill the void (FIG. 5D). The X-Y location of the pin deposited in FIG. 5B remains open. After deposition of (2n) layers are complete with appropriately aligned voids, another Z-pin is deposited in the original X-Y location, penetrating (n) layers deep to bond with the previous pin (FIG. 5E). The Z-pinning process continues in FIG. 5F for layer (2n+n/2) and proceeds accordingly through the thickness of the printed part.

The Z-direction ‘liquid nails’ provided by the fill layer are desirably strategically distributed throughout the part and between successive layers so that every layer will be interconnected by one or more nails. Complete solid fills are possible with this technique, whereby the void holes left behind in previous layers are completely filled by nails in successive layers. Optional embodiments of this invention utilize sparse fill structures (e.g., rectilinear honeycomb-like structures) to create regular interconnected porosity throughout the part. In these embodiments, a software change for new or existing systems is implemented the liquid nails method of this invention would be a site-specific fill operation at strategic locations. A new slicing algorithm would be needed that would determine the appropriate placement of the pins, determine layer patterns that would leave interconnected voids, and have site-specific fill operations.

In exemplary embodiments of this invention, the seam between successive pins is staggered within the bulk structure, similar to the mortar joints in a brick wall. The stagger pattern for seams can depends on several factors, such as including the pin length (n) as measured in number of layers, the number of layers between pin deposits (i), and the spacing of pins in the X-Y plane. The Z-pin approach described in FIGS. 5A-f has a pin length of 4 layers (n=4) and pins are deposited in different holes every 2 layers (i=2). The ratio of (n/i) is an integer value in order for pins to be deposited continuously throughout the structure (ignoring seams). A nomenclature for printing with a pin length (n) and layer frequency (i) is “n-i pins”. For example, FIGS. 5A-F demonstrate the deposition of 4-2 pins. The variation of X-Y spacing and configurations are numerous and varied. An exemplary in-fill pattern is illustrated in FIGS. 6A-B via an orthogonal rectilinear grid in which all of the deposited beads in one layer are aligned along a primary axis (X-axis) and the beads of the following layer are aligned with the orthogonal axis (Y-axis). This base grid pattern alternates throughout the part, leaving a grid of aligned voids throughout the structure. Z-pins were inserted at alternating locations across the X-Y plane. The spacing patterns illustrated in FIG. 6A utilizes an (n/i) ratio of two, and the A-B-C pattern of FIG. 6B includes ratio of three.

The pattern of the voids and fill layer deposits can vary depending on need for the build. FIGS. 7-10 show examples of fill patterns in a build having a rectilinear array of voids 30. Referring to FIGS. 7 and 9, embodiments of this invention incorporate a zigzag fill layer deposition. When a nozzle moves from one void 30 to another without extruding, the melted polymer oozes out from the nozzle tip leaving a trace mark. This can be an important issue for the previously discussed ‘alternating four layer pinning’ algorithm of FIG. 4, as only half number of the voids are filled and the other half of the voids should not blocked by the trace. Moving the nozzle along an alternating angle, or zigzag, path fills the voids 30 in a zigzag direction so that the nozzle does not cross over empty voids. An opposite or mirrored zigzag motion can be used for the four layer pinning embodiment of FIG. 4, such as for filling voids 30′ in FIG. 7. These nail pattern examples are not exhaustive and additional nail patterns are contemplated.

The proper pin parameters for a given in-fill pattern can vary considerably depending upon the material and deposition system being used, as well as the desired performance for the intended application. The theoretical volume of the available hole can be calculated analytically, but the actual ‘fill volume’ of a successfully deposited pin may be below this theoretical limit Additionally, the penetration depth of a single pin (n) is desirably identified for a given material and print system to insure that adequate contact with any underlying pin is made. Also, the ratio between the diameter of the hole (Dh) to the diameter of the extrusion orifice (De) is critical. If the diameter ratio is too small, the pin will likely not penetrate the full distance (n) and an ‘overfill’ condition will result. If the ratio is too large, the thin extruded material will accumulate loosely within the hole and not penetrate appropriately into the surrounding structure (like rope coiling in a bucket).

The optimal fill-volume value can range considerably, from a fraction of a theoretical fill volume to potentially multiples of the fill volume. In embodiments of this invention, desirable bonding between layers has been obtained when the fill extrusion exceeds the theoretical fill volume by 20-60%. Without wishing to be bound by theory, by overfilling the cavity, more material can be forced into the natural voids of the surrounding sparse structure, thus increasing the magnitude and likelihood of mechanical bonding. The optimal value of the fill will be a complex function of the parent structure, the length of the pins, the spacing of the pins, and the rheological properties of the extruded material. For embodiments of this invention, the system gives the optimal filling configuration when the extrusion amount is 80%-160% of the theoretical value of empty volume of a void.

Embodiments of this invention incorporate a method of nozzle wiping during fill layer deposition. As mentioned above, when a nozzle moves from one void to another without extruding, the residual melted polymer flows out from the nozzle tip leaving a trace mark. The liquid nail filling method of embodiments of this invention incorporates a wiping function to clean the nozzle to reduce or eliminate trace material deposited in unwanted places. The nozzle height is kept the same as the last layer height and the nozzle moves across the infill line at the edge of the void so that the residual melted polymer dangling at the nozzle tip is detached (or wiped) by the infill line. The nozzle in some embodiments is wiped in a corner of a void, such as by moving in a diagonal or zigzag fill pattern.

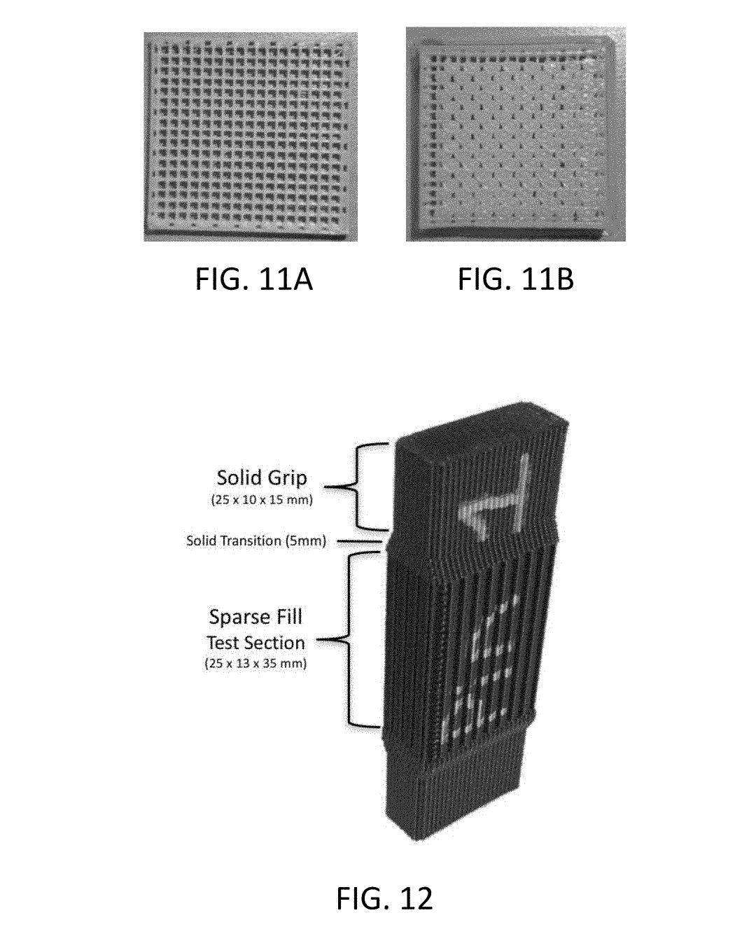

For the linear infill pattern from common slicer software, the gap between infill lines is consistent throughout the domain except at the boundary. The last infill lines column-wise and row-wise are close to the boundary, and the distance between the last infill line and the perimeter is small and not consistent. Also, the issue of the last infill line is that because the nozzle tip changes its direction of movement at the boundary, the void holes are not always a full rectangular shape, but have round edges. In embodiments of this invention, the last infill lines are moved right next to the perimeter so that there is no gap between the perimeter line and the last infill line. Subsequently, the rest of the infill lines are redistributed with equal gap distance. In this way, the sizes of the voids are consistent throughout the domain, and the square shape is ensured. FIG. 11A shows a consistent square infill shape from the method of this invention, and FIG. 11B shows the grid system with pins. Additional shapes such as round, rectangular, triangular and other shapes may be used.

The present invention is described in further detail in connection with the following examples which illustrate or simulate various aspects involved in the practice of the invention. It is to be understood that all changes that come within the spirit of the invention are desired to be protected and thus the invention is not to be construed as limited by these examples.

### EXAMPLES

To demonstrate the method and build of this invention sample specimens were made on a SoliDoodle printer. After creating a 1×1×1 inch cube in SolidWorks® and exporting it as an STL file, the different infill percentages were adjusted to find an acceptable percentage for demonstrating near-complete penetration of the liquid nail. The two infills identified and tested were 30% and 35%. Above 35% seemed to be too small for the extruder to deposit within and any less that 30% seemed to have void holes to large. Once these infills were decided, they were each printed several times at various layer counts. All these samples were printed with black ABS. Once the samples were complete, the Solidoodle Apprentice was used to fill in the voids of the specimens with orange ABS in order to be able to see the difference between the printed specimens and the orange ‘nail’. Unfortunately, the holes were quite small and Repetier Host only had the options to extrude for 1 second, 5 seconds, or 10 seconds, thus the 10 second option was used and while the 10 second extrude was going, the specimens were moved along the extruder in attempt to fill in the holes in the specimens, with resulting overfill.

Once the specimens were created and filled, they were then cut in order to view the cross sections of the filled holes. This was done in order to show how deep the orange ABS was able to go with in the void holes as well as to show if there was good adhesion between the nail and the layers. After sectioning the samples, it was clear that the orange polymer was able to flow to the bottom in some of the voids, and was firmly in place and able to fill in the area between the layers. This provided proof of concept because it demonstrated the ability of the liquid nail concept to go within the layers.

A second phase of testing was done with a MAKERGEAR M2 printer. The plastic was also changed from ABS to PLA due to the ease of use for PLA. The goal of this phase was to create code for automated extrusion in order to create the liquid nails, as well as determining the layer depth the liquid nails were able to successfully penetrate in a 35% rectilinear infill. The code was generated using Python and the layers tested were 4L, SL, 16L, and 32L. The amount of plastic theoretically needed to fill the holes was calculated and later reduced due to error of the printer.

Initially, the same 1×1 inch square used in the first phase was printed with various heights and different amounts of plastic. With the modified code, the MAKERGEAR would begin with printing the square with the 35% infill. Once the desired layer count was achieved, the filament was changed to an alternate color in order to show distinction between the infill and the liquid nails. Once the filament color was changed, the extruder would begin the second phase of the printer, and would fill in the voids. This was achieved by lowering the nozzle into each void hole, and extruding the desired amount of PLA into the hole. Once complete, the nozzle would move to the wall of the void and wipe any excess plastic against the wall before moving onto the next void. Initially, this was done for all of the voids in the infill After creating the sample and imaging the surface, the sample was then sectioned to ensure the nails penetrated the desired depth.

Once the placement of the liquid nails was automated, the pattern for nail placement was altered because realistically, not every void needed to be filled. Three unique patterns were chosen to be further tested and these were known as Skip 1, Skip 1 packed, and Skip 2. The Skip 1 pattern had every other hole filled in a row, then the next row was skipped then the pattern was repeated for the following row (see FIG. 6). Skip 1 packed the same pattern as Skip 1, but no row was skipped, thus every other hole was filled in (see FIG. 5). Skip 2 was done by filling in a hole in a row, skipping two voids and then filling again. Once that row was complete, two rows were skipped and the filling began again (see FIG. 8). Once these patterns were created, the next step was sectioning one to confirm that all the holes were filled. These results proved greater penetration depth as well as improved consistency than the previous manually created nails. The nails also were shown to adhere greatly to the infill as well as flow between the layers to give it almost screw-like features that engaged with the void walls.

In order to evaluate mechanical characteristics of Z-pinned samples, a number of rectangular beams were printed (nominal cross section of 0.25″×0.50″) for mechanical testing. These samples represent the first time that the Z-pinning protocol had been attempted for more than a few layers (˜10), so a number of adjustments were necessary in order to produce stable prints. The sample length often fell short of the prescribed 5″ due to print instabilities. The infill pattern for each of the sampled pictured below are described in Table 1.

TABLE 1

| Sample | Infill Pattern | Max Load (N) |
|---|---|---|
| A | 100% Cross-hatch (solid) | 1176 |
| B | 100% Cross-hatch (solid) | 1229 |
| C | SLIC3R 35% Infill | 239 |
| D | 35% Equal Grid | 477 |
| E | D w/ 8 layer nails | 250 |
| F | D w/ 4 layer nails | 613 |
| G | Same as F but with better quality. | 471 |

The specimens above were subjected to 4-point bend tests. The support span for the samples was 2″ and the load span was 1″ at a cross-head rate of 0.0267″/min. The maximum strength of the relevant samples is shown above. The completely filled samples (A&B) fractured at an average load of ˜1200 N. The sparse infill samples failed at 239 N (SLIC3R) and 477 N (regular grid). By comparison, the samples that contained 8-layer Z-pins failed at an average load of ˜550 N, which is much better than the sparse fill samples that did not contain Z-pins, but not nearly equal to the fully dense samples. In hindsight, 4-point bend tests were considered a poor test of the Z-pin concept since the maximum stress occurs on the outermost surface of the samples, which is not where the Z-pins were located (there were 2 solid contour lines around the exterior edge).

A second set of rectangular samples were printed for tensile testing using the infill strategies described below. Note that in certain instances (A′, B′, D′), the tensile specimens were the remaining sections of the failed 4-point bend specimens used previously. Also note that the tensile specimens did not have a reduced gauge length (i.e., not dog bones), so they are not ‘proper’ specimens for tensile testing.

The tensile test results are shown in Table 2, along with the corresponding infill patterns. Once again, it was observed that the samples with complete solid patterns had the highest strength 4000 N) while the sparse filled samples had significantly lower (˜1300 N). The Z-pin samples were significantly stronger than the sparse filled samples (˜1650 N), but were still not as strong as the solid counterparts.

TABLE 2

| Sample | Infill Pattern | Max Load (N) |
|---|---|---|
| A′ | 100% Cross-hatch (solid) | 3992 |
| B′ | 100% Cross-hatch (solid) | 3961 |
| D′ | 35% Equal Grid | 1219 |
| D-2 | 35% Equal Grid | 1336 |
| G-1 | D w/ 4 layer nails (8 layers deep) | 1539 |
| G-2 | D w/ 4 layer nails (8 layers deep) | 1656 |
| G-3 | D w/ 4 layer nails (8 layers deep) | 1663 |

Inspection of the fracture surfaces for each of the samples revealed a distinct difference in the failure mechanisms. Sample A′ (solid infill) had a large fracture surface that covered >80% of the fracture surface. It is believed that since the printer did not pause during printing, this sample remained hot throughout the deposition process and formed a better bond between subsequent layers than the interrupted builds (required for Z-pinning) However, this effect was largely due to the fact that the sample size is so small relative to the print bed. Interlayer bonding is significantly reduced for larger prints when the previous layer has significant time to cool before subsequent depositions. By comparison, the sparse infill sample had very little of its cross section that shows signs of fracture (primarily around the outskirts of the sample). This explains the relatively weak failure strength of these samples. Inspection of the Z-pinned samples shows that although the interlayer deposits were present, the fracture surface did not pass through (or apparently involve) the Z-pins. Although this gave a more convoluted fracture surface, this indicated that the Z-pins were not appropriately integrated into the layered architecture of the sample. This can be remedied by adjusting the sparse infill geometry closer to the nozzle diameter (to force the Z-pins to expand outward into the surrounding structure rather than curling up like a rope in a bucket).

Tensile specimens were printed on a MAKERGEAR M2 to evaluate the mechanical performance of Z-pinned materials. The machine code for the desktop printer was customized to generate a rectilinear grid pattern in the X-Y plane, having a hole depth of 1.6-2.4 mm (n=8-12 layers), and diameter ratio (Dh/De) of 3 (corresponding to Dh˜1 mm) Samples were either printed without pins (NP) or with pins using the A-B or A-B-C spacing pattern from FIGS. 6A-B. A 35% in-fill pattern was found to provide the appropriate hole diameter and grid spacing needed for the deposition of successful pins. A rectilinear grid using a 57% in-fill was also printed without pins to represent a “constant-mass” control (i.e., having the same mass as the 35% in-fill samples that contained Z-pins). The MAKERGEAR M2 used a 0.35 mm nozzle with a layer height of 0.20 mm The material was standard PLA filament feedstock purchased from 3DXTech and was deposited a nominal temperature of 220° C. A variation on the Z-pinning approach involved the deposition of ‘hot pins’ where the rectilinear grid structure was deposited at the nominal temperature of 220° C., but extrusion of the Z-pins occurred at 240° C. The motivation behind the hot pin concept was to increase the bonding temperature with the surrounding structure as well as reduce the viscosity of the pinning material to improve penetration into the surrounding geometry. The Z-pinning process described here required only software modifications to the printing system, meaning that this technique can be utilized on virtually any open-source desktop FFF or extrusion-based printer.

The geometry of the tensile samples designed for this study is shown in FIG. 12. The upper and lower grip sections of the samples were built with a 100% solid infill through the transition regions. The rectilinear grid section measured 25 mm×13 mm in cross section and did not use a solid outer contour. This allowed each pinned sample to contain 68 pins across the X-Y plane. The grid section extended 35 mm in the build direction (Z-axis), containing ˜175 layers. The tensile samples were tested using a MTS Series 40 Electromechanical Universal Test System with a 100 kN load cell at a strain rate of 5 mm/min. Engineering stress was calculated based on a nominal apparent cross section of 25 mm×13 mm and strain measurements were taken from the machine crosshead displacement. All tensile samples (at least 4 samples for each condition) printed with neat PLA failed in the grid gauge section, well away from the solid transition regions.

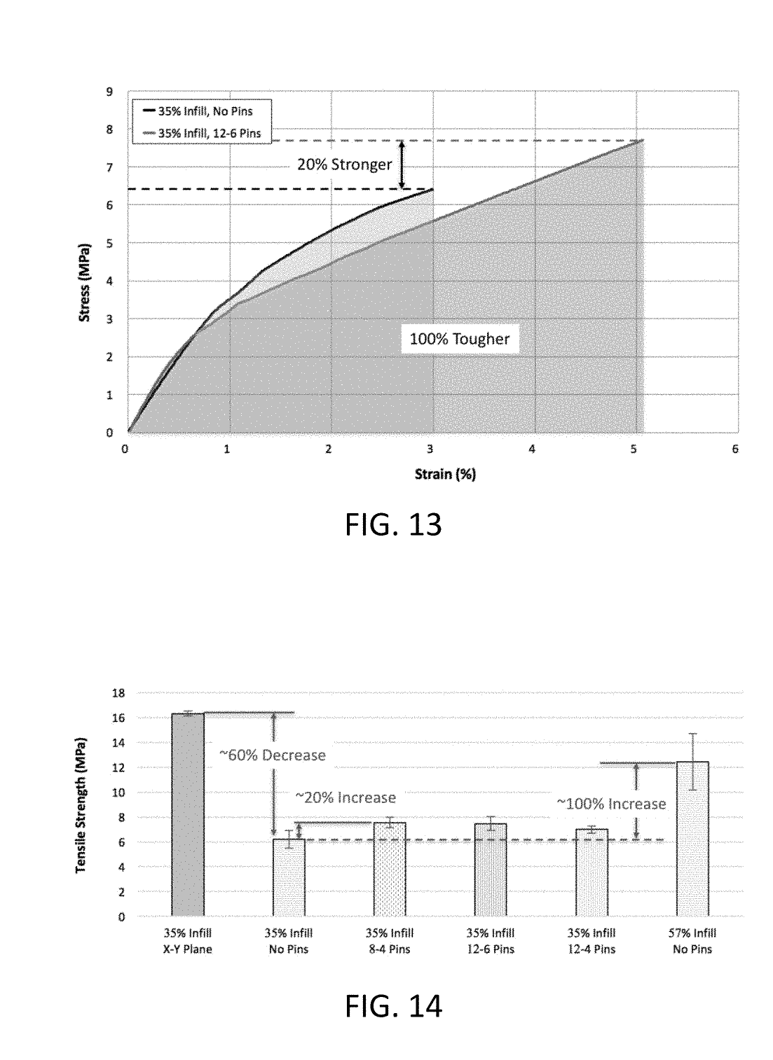

FIG. 13 compares the tensile properties of a 35% infill sample with 12-6 Z-pins against a control sample without pins. The pinned sample demonstrates a slightly higher ultimate tensile strength (20% increase) and a dramatically improved toughness (100% increase). The strain to failure for the Z-pinned sample increased by more than 60% and the stiffness of the samples were nearly identical.

The ultimate tensile strength across the variety of samples printed is compiled in FIG. 14. The first two samples demonstrated the expected reduction in strength for un-pinned 35% infill samples loaded in the Z-direction as compared to the X-Y plane (˜60% reduction). The second sample (35% infill, no pins) served as the baseline for evaluating the effectiveness of a variety of pin configurations. The 8-4 and 12-6 pin configurations both showed a statistically significant improvement in tensile strength compared to the un-pinned sample (˜20% increase). The samples printed with 12-4 pins demonstrated a slight increase (˜10%), but it is estimated that the higher frequency of pausing the print to insert pins resulted in a higher number of defects and poorer bonding between successive layers. The 57% infill pattern without pins resulted in a significantly higher tensile strength than any of the 35% infill samples tested in the Z-direction. On a per-mass basis, the 35% infill samples that contained pins were equivalent to the un-pinned 57% infill samples, but the strength of the 57% infill sample was significantly higher (˜60%) than any of the pinned samples and almost twice as high as the un-pinned 35% infill samples. This indicates that for the same mass using the current pin printing configuration for neat PLA, improved strength can be attained by increasing the density of the infill pattern rather than inserting Z-pins. However, further optimization of the pin configuration (e.g., pin volume, diameter ratio, penetration depth, stagger pattern, etc.) may likely reverse this trend. For instance, using a hot pin approach, where the deposition temperature of the Z-pin was increased by 20° C., resulted in an additional 10% increase in tensile strength.

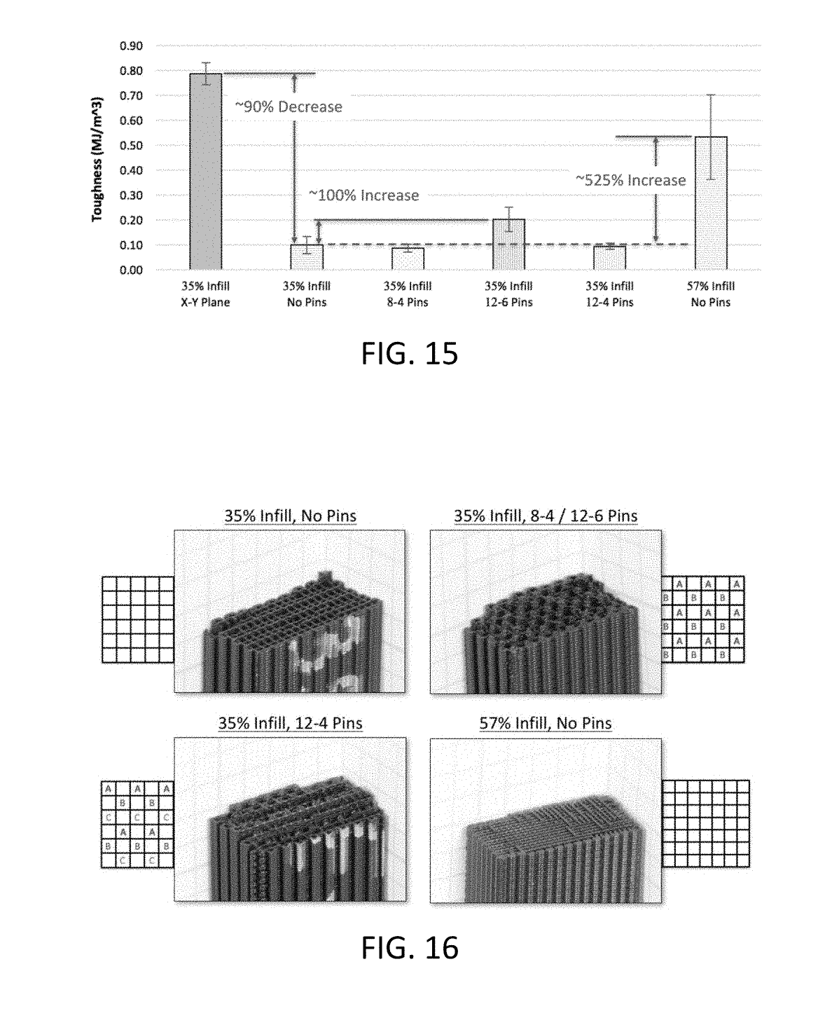

A similar trend can be observed in the measured toughness of the printed samples in FIG. 15. The reduction in toughness due to print direction was dramatic (˜90% reduction in the Z-direction). As illustrated in FIG. 13, the 12-6 pinned sample doubled the toughness in the Z-direction, but the toughness of the 57% infill samples without pins was still far superior.

Inspection of the fracture surfaces of the tensile samples showed a distinct difference in the exposed surface area (FIG. 16). The samples without pins (35% and 57% infill) had a relatively smooth fracture surface, indicating that the crack in the specimen likely propagated across a single layer (or layer interface) in the X-Y plane with very little deflection. The pinned samples, regardless of configuration, resulted in a very tortuous fracture surface, indicating that the crack was deflected several times as it worked across the specimen's cross section. The cracks generally deflected to re-route the path between embedded pins. The additional energy absorbed by the structure was evident in damage created parallel to the load direction as the crack paths traversed across multiple layers. It was observed that the crack deflects a specific number of layers in each case that matches the pin length (n=12). As expected, this identified the bond between successive pins as the weak link, but provides guidance on further configurations to improve both strength and toughness.

Thus, the invention provides a method of Z-direction nailing for additive manufacturing. The liquid nails of this invention provide an adjustable tool for increasing Z-direction strength for a component build.

The invention illustratively disclosed herein suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

We claim:

1. A method for making an article with an additive manufacturing machine comprising the steps of:
depositing an initial layer of a material along a 2D plane with the additive manufacturing machine so that the layer defines at least one void area having a depth measured in an axis direction that is perpendicular to the 2D plane; and
depositing a fill layer of the material or a second material on top of the initial layer with the additive manufacturing machine so that a portion of the material or the second material deposited in the fill layer extends into the at least one void to form an interlocking feature between the initial layer and the fill layer.

2. The method of claim 1, wherein the fill layer extends in the Z-direction.

3. The method of claim 1, wherein the at least one void and the fill layer each extends through more than one layer of material.

4. The method of claim 1, wherein the fill layer comprises a polymer material different than the material of the initial layer.

5. The method of claim 1, further comprising wiping a nozzle of the additive manufacturing machine against a wall of each of the at least one void after depositing the corresponding fill layer in the each of the at least one void.

6. The method of claim 1, further comprising filling the at least one void over a predetermined expected volume of the at least one void.

7. The method of claim 1, further comprising:
depositing the initial layer of a material so that the layer defines a plurality of void areas having a depth measured in an axis direction that is perpendicular to the 2D plane; and
depositing a fill layer in each of the plurality of void areas.

8. The method of claim 7, further comprising leaving a second plurality of void areas unfilled, wherein the fill layer comprises a predetermined fill pattern across the initial layer of material.

9. The method of claim 8, wherein the fill pattern comprises a zigzag pattern.

10. The method of claim 1, further comprising depositing a first plurality of additional layers on top of the initial layer, wherein the at least one void area extends through the initial layer and the additional layers.

11. The method of claim 10, further comprising depositing a second plurality of additional layers on top of the initial layer and the first plurality of additional layers so that a further void area is formed in the second plurality of additional layers and a portion of the first plurality of additional layers, the further void area having a further depth measured in the axis direction that is perpendicular to the 2D plane, and offset in the axis direction from the at least one void.

12. A three-dimensional article of manufacture made with an additive manufacturing machine comprising:
an initial layer of a material deposited in a 2D plane and defining at least one void area having a depth measured in an axis direction that is perpendicular to the 2D plane;
a fill layer of a fill layer material deposited on top of the initial layer; and
wherein a portion of the fill layer material deposited in the fill layer extends into the at least one void area to form an interlocking feature between the initial layer and the fill layer.

13. The article of claim 12, wherein the at least one void and the portion of the fill layer each extends through more than one layer of material to form the interlocking feature between the more than one layer of material.

14. The article of claim 12, wherein the fill layer comprises a polymer material the different than the material of the initial layer.

15. The article of claim 12, wherein the at least one void area is filled with more material volume than a predetermined expected volume of the at least one void.

16. The article of claim 12, further comprising a plurality of void areas having a depth measured in an axis direction that is perpendicular to the 2D plane, wherein the fill layer material deposited in the fill layer extends into each of the plurality of void area to form an interlocking feature between the initial layer and the fill layer.

17. The article of claim 16, further comprising leaving a second plurality of void areas unfilled, wherein the fill layer comprises a predetermined fill pattern across the initial layer of material.

18. The article of claim 17, wherein the fill pattern comprises a zigzag pattern.

19. The article of claim 12, further comprising a first plurality of additional layers on top of the initial layer, wherein the at least one void area extends through the initial layer and the additional layers.

20. The article of claim 19, further comprising a second plurality of additional layers on top of the initial layer and the first plurality of additional layers so that a further void area is formed in and through the second plurality of additional layers and a portion of the first plurality of additional layers, the further void area having a further depth measured in the axis direction that is perpendicular to the 2D plane, and offset in the axis direction from the at least one void.
